(19) United States
(12) Patent Application Publication
(10) Pub. No.: US 2022/0051574 A1
(43) Pub. Date: Feb. 17, 2022

(54) FLIGHT ROUTE GENERATION METHOD, CONTROL DEVICE, AND UNMANNED AERIAL VEHICLE SYSTEM

(71) Applicant: SZ DJI TECHNOLOGY CO., LTD., Shenzhen (CN)

(72) Inventors: Renli SHI, Shenzhen (CN); Jinsong LI, Shenzhen (CN); Zhenhao HUANG, Shenzhen (CN); Fu XU, Shenzhen (CN)

(21) Appl. No.: 17/508,381

(22) Filed: Oct. 22, 2021

Related U.S. Application Data
(63) Continuation of application No. PCT/CN2019/083735, filed on Apr. 22, 2019.

(51) Int. Cl. G08G 5/00; G06F 16/29

(52) U.S. Cl. CPC G08G 5/0034; G06F 16/29; G08G 5/0069; G08G 5/0086

(57) ABSTRACT

A flight route generation method includes obtaining an initial route, determining a plurality of sampling points from the initial route, and, for each sampling point of the plurality of sampling points, determining a buffer area of the sampling point and determining an expansion height of the sampling point according to heights of a plurality of points in the buffer area of the sampling point. The method further includes generating a flight route according to expansion heights and coordinate positions of the plurality of sampling points.

### CROSS-REFERENCE TO RELATED APPLICATION

This application is a continuation of International Application No. PCT/CN2019/083735, filed Apr. 22, 2019, the entire content of which is incorporated herein by reference.

### TECHNICAL FIELD

The present disclosure relates to the technical field of intelligent control and, more particularly, to a flight route generation method, a control device, and an unmanned aerial vehicle system.

### BACKGROUND

Unmanned aerial vehicle is widely applied in fields like agriculture or unmanned aerial vehicle photographing due to its features of fast flight speed, flexible operation, etc. For example, an unmanned aerial vehicle can be used to perform terrain photographing in undulating terrain. In the process of photographing, to ensure that sampling intervals on the ground remain consistent and overlap rates remain consistent, the unmanned aerial vehicle needs to fly in a terrain-following flight mode. Terrain-following flight means that the unmanned aerial vehicle adjusts flying height of the unmanned aerial vehicle according to terrain of the undulating terrain, and the unmanned aerial vehicle maintains a constant altitude difference with the undulating terrain during the flight.

Currently, a route generation method for terrain-following flight is mainly to obtain heights of sampling points through a digital surface model, and to determine a terrain-following flight route according to the heights of the sampling points. However, it has been found in practice that based on the terrain-following flight route generated by this method, the unmanned aerial vehicle may collide with a ground object when flying in the undulating terrain with a large altitude difference.

### SUMMARY

In accordance with the disclosure, there is provided a flight route generation method including obtaining an initial route, determining a plurality of sampling points from the initial route, and, for each sampling point of the plurality of sampling points, determining a buffer area of the sampling point and determining an expansion height of the sampling point according to heights of a plurality of points in the buffer area of the sampling point. The method further includes generating a flight route according to expansion heights and coordinate positions of the plurality of sampling points.

Also in accordance with the disclosure, there is provided a control device including a memory storing a computer program and a processor. The processor is configured to execute the computer program to obtain an initial route, determine a plurality of sampling points from the initial route, and, for each sampling point of the plurality of sampling points, determine a buffer area of the sampling point and determine an expansion height of the sampling point according to heights of a plurality of points in the buffer area of the sampling point. The processor is further configured to execute the computer program to generate a flight route according to expansion heights and coordinate positions of the plurality of sampling points.

Also in accordance with the disclosure, there is provided an unmanned aerial vehicle including a vehicle body, a propulsion device arranged at the vehicle body, and a control device arranged at the vehicle body and configured to control the propulsion device to drive the unmanned aerial vehicle to move. The control device includes a memory storing a computer program and a processor. The processor is configured to execute the computer program to obtain an initial route, determine a plurality of sampling points from the initial route, and, for each sampling point of the plurality of sampling points, determine a buffer area of the sampling point and determine an expansion height of the sampling point according to heights of a plurality of points in the buffer area of the sampling point. The processor is further configured to execute the computer program to generate a flight route according to expansion heights and coordinate positions of the plurality of sampling points.

### BRIEF DESCRIPTION OF THE DRAWINGS

In order to explain the technical solutions in the embodiments of the present disclosure more clearly, reference is made to the accompanying drawings, which are used in the description of the embodiments. Obviously, the drawings in the following description are only some embodiments of the present disclosure, and other drawings can be obtained from these drawings without any inventive effort for those of ordinary skill in the art.

FIG. 1 is a schematic structural diagram of an unmanned aerial vehicle system according to an embodiment of the present disclosure.

FIG. 2 is a schematic flow chart of a flight route generation method according to an embodiment of the present disclosure.

FIG. 3 is a top view of a digital elevation model according to an embodiment of the present disclosure.

FIG. 4 is a side view of a digital elevation model according to an embodiment of the present disclosure.

FIG. 5 is a top view of an initial route according to an embodiment of the present disclosure.

FIG. 6 is a side view of an initial route according to an embodiment of the present disclosure.

FIG. 7 is a top view of sampling points according to an embodiment of the present disclosure.

FIG. 8 is a side view of sampling points according to an embodiment of the present disclosure.

FIG. 9 is a schematic diagram of a buffer area of a sampling point according to an embodiment of the present disclosure.

FIG. 10 is a schematic diagram of another buffer area of a sampling point according to an embodiment of the present disclosure.

FIG. 11 is a schematic diagram of another buffer area of a sampling point according to an embodiment of the present disclosure.

FIG. 12 is a schematic diagram showing sampling points after a height expansion according to an embodiment of the present disclosure.

FIG. 13 is a schematic diagram showing sampling points after another height expansion according to an embodiment of the present disclosure.

FIG. 14 is a schematic diagram of a flight route according to an embodiment of the present disclosure.

FIG. 15 is a schematic flow chart of another flight route generation method according to an embodiment of the present disclosure.

FIG. 16 is a schematic diagram showing a manner of selecting valid sampling points according to an embodiment of the present disclosure.

FIG. 17 is a schematic diagram showing another manner of selecting valid sampling points according to an embodiment of the present disclosure.

FIG. 18 is a schematic diagram of another flight route according to an embodiment of the present disclosure.

FIG. 19 is a schematic diagram of another flight route according to an embodiment of the present disclosure.

FIG. 20 is a schematic structural diagram of a control device according to an embodiment of the present disclosure.

### DETAILED DESCRIPTION OF THE EMBODIMENTS

The technical solutions in the embodiments of the present disclosure will be described in detail with reference to the accompanying drawings. Obviously, the described embodiments are only some of rather than all the embodiments of the present disclosure. Based on the described embodiments, all other embodiments obtained by those of ordinary skill in the art without inventive effort shall fall within the scope of the present disclosure.

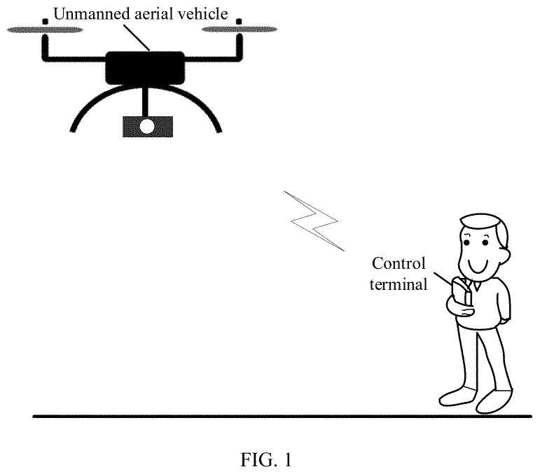

FIG. 1 shows an unmanned aerial vehicle system according to an embodiment of the present disclosure. The unmanned aerial vehicle system includes an unmanned aerial vehicle and a control terminal.

The unmanned aerial vehicle may be a rotor mobile robot, such as a four-rotor mobile robot, a six-rotor mobile robot, or an eight-rotor mobile robot. The unmanned aerial vehicle may include a propulsion device arranged at a vehicle body of the unmanned aerial vehicle, which is configured to provide mobile propulsion for the unmanned aerial vehicle, and may include one or more of an engine, a propeller, a motor, or an electronic speed controller. The unmanned aerial vehicle may also include a gimbal and a photographing device, and the photographing device is mounted at a main body of the unmanned aerial vehicle through the gimbal. The photographing device is configured to perform image or video photographing during movement of the unmanned aerial vehicle, including but not limited to a multispectral imager, a hyperspectral imager, a visible light camera, an infrared camera, etc. The gimbal is a multi-axis transmission and stabilization system. A gimbal motor compensates for a photographing angle of an imaging device by adjusting a rotation angle of a rotation shaft, and prevents or reduces jitter of the imaging device by providing an appropriate buffer mechanism.

The control terminal can establish a wireless communication connection with the unmanned aerial vehicle to realize control of the unmanned aerial vehicle. For example, the control terminal can control a movement state (such as position, speed, acceleration, etc.) of the unmanned aerial vehicle, and/or control rotation direction of the gimbal of the unmanned aerial vehicle, and/or control the unmanned aerial vehicle to take an image and/or a video. The control terminal can be a remote control, a smart phone, a tablet computer, a computer, a smart bracelet, etc.

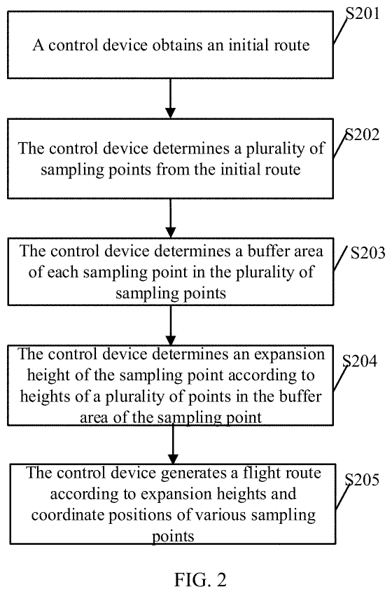

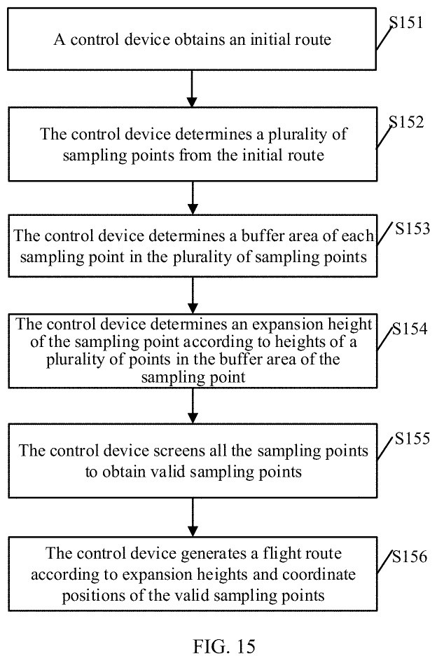

The unmanned aerial vehicle system may also include a control device arranged at a body of the control terminal or the vehicle body of the unmanned aerial vehicle, and the control device is configured to generate a flight route of the unmanned aerial vehicle, which may be a terrain-following flight route of the unmanned aerial vehicle. For specific implementation of the control device to generate the flight route, reference can be made to FIGS. 2 and 15.

FIG. 2 is a schematic flow chart of a flight route generation method according to an embodiment of the present disclosure. The method can be applied to the control device described above. As shown in FIG. 2, the flight route generation method includes the following processes.

S201, the control device obtains an initial route.

When the unmanned aerial vehicle needs to perform a terrain-following flight, the control device may obtain an initial route, which may refer to a non-standard terrain-following flight route. The initial route may be generated by the control device, or obtained from another device by the control device.

In some embodiments, the initial route may be generated through an external instruction. The control device is arranged at the unmanned aerial vehicle, and the external instruction may be an instruction sent by a control terminal connected to the unmanned aerial vehicle. For example, the external instruction is a first instruction, and the control device may receive the first instruction sent by the control terminal. The first instruction may include position information of a plurality of position points, and the position information includes coordinate positions and heights of the position points. The control device may sequentially connect all of the plurality of position points to obtain the initial route according to the position information of the plurality of position points. As another example, the external instruction is a second instruction, and the control device may receive the second instruction sent by the control terminal. The second instruction may include a flight route, which may be a historical flight route or a flight route set by a user at the control terminal, and the control device may determine the flight route included in the second instruction as the initial route.

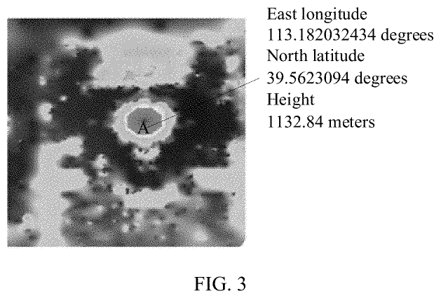

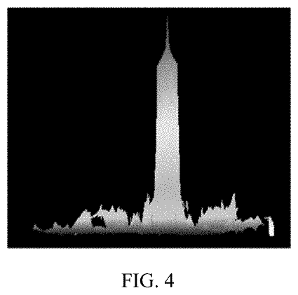

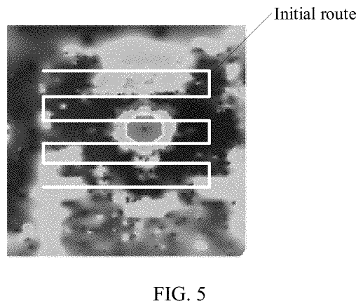

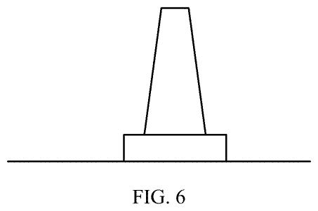

In some other embodiments, the initial route may be obtained and generated through a database, which includes one or more of a digital elevation model, a historical flight route, or a digital surface model, and can be stored in the control device or another device connected to the control device. For example, the database of the control device includes historical flight routes of a plurality of flight areas. The control device may obtain the position information of the flight area, obtain the historical flight route of the flight area from the database according to the position information of the flight area, and use the historical flight route as the initial route. As another example, the database of the control device includes a digital elevation model, which is generated according to a plurality of environmental images of the flight area. A top view of the digital elevation model of the flight area is shown in FIG. 3, and the digital elevation model includes the coordinate positions and heights of three-dimensional feature points corresponding to various pixel points in the environmental images. As shown in FIG. 3, the coordinate position of a three-dimensional feature point corresponding to pixel point A is (113.182032434 degrees east longitude, 39.5623094 degrees north latitude), and the height is 1132.84 meters. A side view (i.e., a height map) of the digital elevation model of the flight area is shown in FIG. 4, which can reflect height variations of the three-dimensional feature points corresponding to the various pixel points. The control device can generate the initial route according to the digital elevation model of the flight area, and a top view of the initial route is shown in FIG. 5, where a polyline represents the initial route. A side view of the initial route is shown in FIG. 6, from which the height variations of the three-dimensional feature points corresponding to the various pixel points can be known.

In some embodiments, the method also includes, before process S201, obtaining the plurality of environmental images photographed by the unmanned aerial vehicle during a level flight to the flight area, and determining the digital elevation model according to the plurality of environmental images, the digital elevation model including the coordinate positions and heights of the three-dimensional feature points corresponding to the various pixel points in the environmental images.

The control device can obtain the plurality of environmental images photographed by the unmanned aerial vehicle during the level flight to the flight area. Photographing time intervals of every two adjacent images in the plurality of environmental images may be the same, and the level flight means that the unmanned aerial vehicle keeps flying in a straight horizontal line. Further, the digital elevation model can be determined according to the plurality of environmental images.

S202, the control device determines a plurality of sampling points from the initial route.

The control device may perform sampling processing on the initial route at a fixed sampling interval or non-fixed sampling intervals to obtain a plurality of sampling points. The non-fixed sampling interval means that the sampling interval is a value that changes randomly, that is, distances between every two adjacent sampling points may be different. For example, the non-fixed sampling intervals are 3 m and 4 m, etc. The control device may obtain a first sampling point at a starting point of the initial route, then obtain a second sampling point at an interval of 3 m and obtain a third sampling point at an interval of 4 m, and so on. That is, an interval between the first sampling point and the second sampling point is 3 m, and an interval between the second sampling point and the third sampling point is 4 m. The fixed sampling interval means that the sampling interval is a fixed value, so that the distances between every two adjacent sampling points are the same (i.e., a horizontal distance). For example, the fixed sampling interval is 2 m, and the control device obtains one sampling point from the initial route at a horizontal distance of 2 m, so that the horizontal distances between every two adjacent sampling points are all 2 m.

In some embodiments, the control device may perform sampling processing on the initial route at the fixed sampling interval. For example, the fixed sampling interval is a preset sampling interval, and the control device may use the preset sampling interval to perform sampling processing on the initial route to obtain the plurality of sampling points. If the obtained sampling points are too few, then change of the flight route cannot be validly reflected, meaning of the terrain-following flight is lost, and potential safety hazard may even be caused; if the obtained sampling points are too many, then number of times of up-down adjustment of the unmanned aerial vehicle is increased, which requires more power consumption, so that operation efficiency is affected. Also, frequent adjustments of route altitude can also negatively impact the photographing and photographing position calculation. Therefore, the control device can set the preset sampling interval according to altitude adjustment times, power consumption, photographing stability, etc.

In some embodiments, the preset sampling interval may be a second preset distance, and the control device may use the second preset distance to perform sampling processing on the initial route to obtain the plurality of sampling points, that is, one point is collected from the initial route as one sampling point at every second preset distance, so that the plurality of sampling points are obtained.

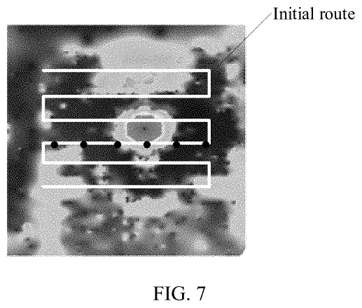

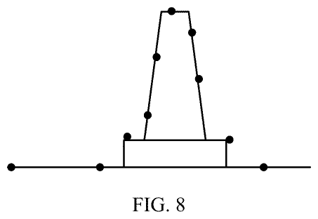

For example, the control device may perform sampling processing on the initial route at the second preset distance to obtain the plurality of sampling points. A top view of the sampling points is shown in FIG. 7, where dots on the initial route are the sampling points (only part of the sampling points are shown), and the distances between every two adjacent sampling points on the initial route are the same. A side view of the sampling points is shown in FIG. 8, where only part of the sampling points are shown, and the height variations of the various sampling points can be known from FIG. 8.

S203, the control device determines a buffer area of each sampling point in the plurality of sampling points.

Since there may be a relatively high object between every two adjacent sampling points, such as a building, or there is high terrain between every two adjacent sampling points, the unmanned aerial vehicle is easily caused to collide with a ground object if the flight route is directly generated according to heights of the sampling points. Therefore, the control device can determine a buffer area of each sampling point in the plurality of sampling points, and the buffer area of each sampling point refers to an expansion area where the corresponding sampling point is located.

In some embodiments, the buffer area of the sampling point may refer to an area on the initial route with the sampling point as a center point. For example, the buffer area of the sampling point may refer to an area on the initial route that expands a first preset distance to both sides along the initial route with the sampling point as the center. The first preset distance may be set by the user, or determined according to terrain undulation change of the current flight area. For example, if the terrain undulation change is relatively large, the first preset distance is set to a larger value; if the terrain undulation change is relatively small, the first preset distance is set to a smaller value.

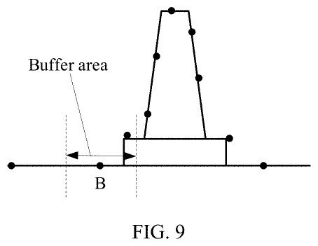

For example, as shown in FIG. 9, the initial route includes a sampling point B, and an area between two dashed lines is the buffer area of the sampling point B. The buffer area of the sampling point B is an area that expands a same distance to both sides along the initial route with the sampling point B as the center, that is, the sampling point B is the center point of the buffer area of the sampling point B.

In some embodiments, when the buffer area of the sampling point is the area on the initial route with the sampling point as the center, in order to make the buffer area cover more sampling points and make the buffer areas of adjacent sampling points partially overlap, the control device can set radius of the buffer area to be greater than or equal to the preset sampling interval, so that omission during sampling can be validly avoided, and collision between the unmanned aerial vehicle and the ground object during flight path planning can be avoided.

In some other embodiments, the buffer area of the sampling point may refer to an area on the initial route with points other than the sampling point as the center point. For example, the buffer area of the sampling point is an area on the initial route that expands a first distance to the left along the initial route with the sampling point as an origin, and expands a second distance to the right along the initial route with the sampling point as the origin. The first distance is different from the second distance, and if the first distance is greater than the second distance, the sampling point is located to the right of the center point of the buffer area of the sampling point; if the first distance is smaller than the second distance, the sampling point is located to the left of the center point of the buffer area of the sampling point.

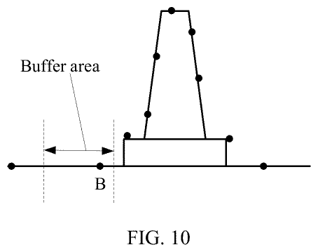

For example, as shown in FIG. 10, an area between two dashed lines is the buffer area of the sampling point B. Assuming that the first distance is 10 m and the second distance is 4 m, the buffer area of the sampling point B is an area expanding to the left by 10 m along the initial route with the sampling point B as the origin, and expanding to the right by 4 m along the initial route with the sampling point B as the origin.

The buffer area of the sampling point may include the sampling point and other sampling points adjacent to the sampling point, and numbers of sampling points included in every two buffer areas may be the same or different. Every two adjacent buffer areas can partially overlap or not overlap at all, and sizes of every two buffer areas may be the same or different, which are not limited by the present disclosure.

S204, the control device determines an expansion height of the sampling point according to heights of a plurality of points in the buffer area of the sampling point.

The expansion height of the sampling point determined by the control device may be the same as or different from an initial height of the sampling point. The plurality of points in the buffer area of the sampling point may include all points in the buffer area. For example, the plurality of points may include all the sampling points in the buffer area and all points on the initial route that are not sampled in the buffer area. The plurality of points in the buffer area of the sampling point may also include some points in the buffer area. For example, the plurality of points may include some sampling points in the buffer area or/and some points on the initial route that are not sampled in the buffer area.

In some embodiments, the control device may determine the expansion height of the sampling point according to the heights of all points in the buffer area of the sampling point. For example, the control device may determine the expansion height of the sampling point according to the coordinate positions and heights of the three-dimensional feature points corresponding to all pixel points in the buffer area of the sampling point. Specifically, the control device may obtain the heights of all points in the buffer area of the sampling point, and determine a maximum height among the heights of all points in the buffer area of the sampling point as the expansion height of the sampling point. In this case, if the initial height of the sampling point is the maximum height among the heights of all points in the buffer area, the determined expansion height of the sampling point is the same as the initial height of the sampling point. The control device may also calculate an average height according to the heights of all points in the buffer area of the sampling point or determine a height value through another suitable calculation method, and determine the average height or the height value determined by another suitable calculation method as the expansion height of the sampling point.

In some other embodiments, the control device may obtain height of a start feature point and height of an end feature point of the buffer area of the sampling point, obtain heights of various sampling points in the buffer area of the sampling point, and determine the expansion height of the sampling point according to the height of the start feature point, the height of the end feature point, and the heights of the various sampling points in the buffer area of the sampling point.

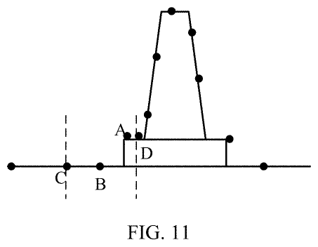

The start feature point and the end feature point refer to boundary points of the buffer area, which can specifically be sampling points or non-sampling points, the non-sampling point referring to a point that is not sampled at boundary of the buffer area on the initial route. For example, as shown in FIG. 11, point C is the start feature point of the buffer area of the sampling point B, point D is the end feature point of the buffer area of the sampling point B, and points A and B are the sampling points in the buffer area of the sampling point B. The control device can obtain height of the feature point C, height of the feature point D, and heights of the points B and A in the buffer area of the sampling point B, and determine the expansion height of the sampling point according to the height of the feature point C, the height of the feature point D, and the heights of the points B and A.

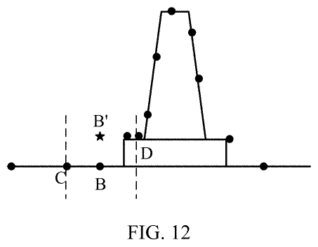

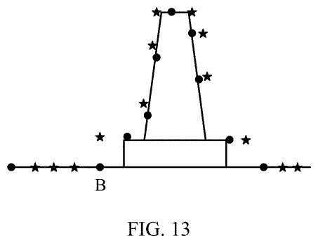

In some embodiments, the control device may determine the maximum height among the height of the start feature point, the height of the end feature point, and the heights of the various sampling points in the buffer area of the sampling point as the expansion height of the sampling point. For example, as shown in FIG. 12, after obtaining the height of the feature point C, the height of the feature point D, and the heights of the points B and A in the buffer area of the sampling point B, the control device determines the maximum height among the height of the feature point C, the height of the feature point D, and the heights of the points B and A in the buffer area of the sampling point B as the expansion height of the sampling point. B′ represents a sampling point after a height expansion. After expansion heights of the various sampling points are obtained through the above method, the sampling points after height expansions are shown in FIG. 13, where dots represent the sampling points of the initial heights, and pentagrams represent the sampling points after the height expansions. As can be seen in FIG. 13, the coordinate position of the sampling point of the initial height is the same as that of the corresponding sampling point after the height expansion, and the heights thereof are the same or the expansion height is greater than the initial height. For example, the initial height of the sampling point B is smaller than the expansion height of the sampling point B.

In some other embodiments, the control device may calculate the average height of the height of the start feature point, the height of the end feature point, and the heights of the various sampling points in the buffer area of the sampling point, and determine the average height as the expansion height of the sampling point. The expansion heights in the buffer area may also be determined through another suitable calculation method, which is not limited herein.

S205, the control device generates the flight route according to the expansion heights and the coordinate positions of the various sampling points.

The control device can sequentially connect the various sampling points after the height expansions according to the coordinate positions of the various sampling points to obtain the flight route. The control device can also increase the expansion heights of the various sampling points, and generate the flight route according to the sampling points after the height expansions and the coordinate positions of the sampling points.

In some embodiments, process S205 includes: adding a preset height to the expansion height of the sampling point, and generating the flight route according to the sampling points after the preset height is added and the coordinate positions of the sampling points. A height obtained by adding the preset height to the expansion height of the sampling point is also referred to as an “increased height” of the sampling point. Correspondingly, generating the flight route according to the sampling points after the preset height is added and the coordinate positions of the sampling points can mean generating the flight route according to the increased heights of the sampling points and the coordinate positions of the sampling points.

In order to avoid the collision between the unmanned aerial vehicle and the ground object, the control device can add the preset height to the expansion height of the sampling point, and then sequentially connect the sampling points after the preset heights are added according to the coordinate positions of the various sampling points to obtain the flight route. The preset height may be set by the user, or set according to the terrain undulation change of the flight area. For example, if the terrain undulation change is relatively large, the preset height is set to a larger value; if the terrain undulation change is relatively small, the preset height is set to a smaller value.

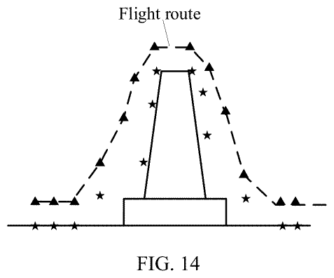

For example, as shown in FIG. 14, triangles represent the sampling points after the preset heights are added, and dashed line represents the flight route. The coordinate position of the sampling point after the height expansion is the same as that of the corresponding sampling point after the preset height is added, and the heights of the sampling points after the preset heights are added are all greater than the heights of the corresponding sampling points after the height expansions.

In the embodiments of the present disclosure, the control device can obtain the buffer areas of the various sampling points, determine the expansion heights of the sampling points according to the heights of the plurality of points in the buffer areas, and determine the flight route according to the expansion heights and the coordinate positions of the various sampling points, so that the terrain-following flight can be realized, and the problem of collision between the unmanned aerial vehicle and the ground object when there is high object or high terrain between every two adjacent sampling points can be avoided, which improves flight safety of the unmanned aerial vehicle.

FIG. 15 is a schematic flow chart of another flight route generation method according to an embodiment of the present disclosure. The method can be applied to the control device described above. As shown in FIG. 15, the flight route generation method includes the following processes.

S151, the control device obtains an initial route.

S152, the control device determines a plurality of sampling points from the initial route.

S153, the control device determines a buffer area of each sampling point in the plurality of sampling points.

S154, the control device determines an expansion height of the sampling point according to heights of a plurality of points in the buffer area of the sampling point.

For explanation of processes S151-S154, reference can be made to the explanation of processes S201-S204 in FIG. 1, which is not repeated herein.

S155, the control device screens all the sampling points to obtain valid sampling points.

In order to ensure that waypoints on the flight route can match waypoints on a terrain-following flight route and to reduce power consumption caused by speed change and altitude adjustment, the control device can screen (i.e., simplify) all the sampling points to obtain valid sampling points. The valid sampling points are waypoints that can better embody ups and downs of the terrain-following flight route.

In some embodiments, the control device sequentially connects the sampling points to obtain connection lines of all the sampling points, and screens the sampling points according to characteristic information of the connection lines to obtain the valid sampling points.

For example, in some embodiments, the characteristic information of the connection line may include slope of the connection line, and specifically, the slope of the connection line is an absolute value of the slope. The control device can sequentially connect the sampling points from a start sampling point or an end sampling point to obtain the connection lines of all the sampling points. If the slope of the connection line is smaller than a preset slope value, the sampling point near an end of the end sampling point is deleted; if the slope of the connection line is greater than or equal to the preset slope value, the sampling points on the connection line are retained. The start point sampling refers to a sampling point closest to a takeoff position point of the unmanned aerial vehicle, and the end sampling point refers to a sampling point farthest from the takeoff position point of the unmanned aerial vehicle.

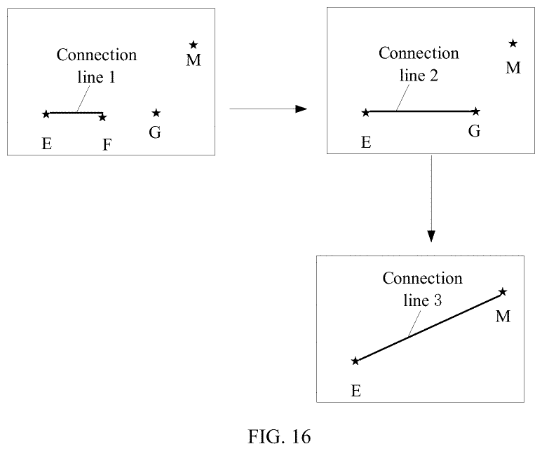

For example, as shown in FIG. 16, the plurality of sampling points include sampling points E, F, G, and M, and the sampling point E is the start sampling point. The control device can connect E and F to obtain connection line 1, and if slope of the connection line 1 is smaller than the preset slope value, the sampling point F is deleted. The control device continues to connect the sampling points E and G to obtain connection line 2, and if slope of the connection line 2 is smaller than the preset slope value, the sampling point G is deleted. Further, the control device connects the sampling points E and M to obtain connection line 3, and if slope of the connection line 3 is greater than the preset slope value, the sampling points E and M are used as the valid sampling points. Then, the control device repeats the above processes to connect the sampling point M and an adjacent point to the sampling point M until all the valid sampling points are determined.

In some other embodiments, the control device can screen all the sampling points according to a Lamer-Douglas-Puck algorithm to obtain the valid sampling points.

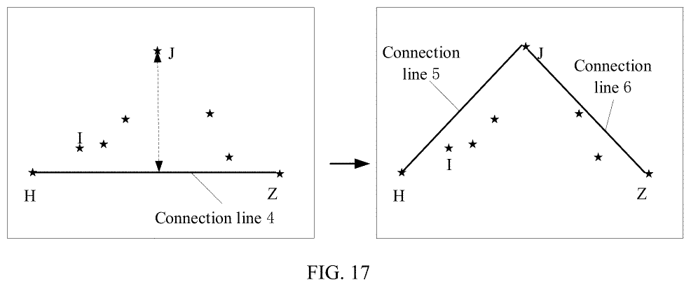

For example, as shown in FIG. 17, the plurality of sampling points include sampling points H, I, J, . . . , and Z, where H is the start sampling point and Z is the end sampling point. The control device can screen the sampling points through the following processes. s1, the control device connects the sampling points H and Z to obtain connection line 4. s2, the control device obtains a sampling point corresponding to the farthest distance among distances from each sampling point to the connection line 4 in the multiple sampling points, and for example, assuming that the distance from the sampling point J to the connection line 4 is the farthest. s3, if the farthest distance is smaller than a preset threshold, the sampling points H and Z are used as the valid sampling points, and the sampling points between the sampling points H and Z are determined as invalid sampling points. If the farthest distance is greater than or equal to the preset threshold, the sampling points H and J are connected to obtain connection line 5, and the sampling points Z and J are connected to obtain connection line 6. s4, the control device calculates the distances from each sampling point between the sampling point H and the sampling point J to the connection line 5, calculates the distance from each sampling point between the sampling point J and the sampling point Z to the connection line 6, and further, executes s3 or s4. The control device repeats the above processes to select all the valid sampling points.

In some other embodiments, the control device may also screen according to another characteristic information of the sampling points to obtain the valid sampling points, and the above embodiments are only exemplary and are not limited herein.

S156, the control device generates the flight route according to expansion heights and coordinate positions of the valid sampling points.

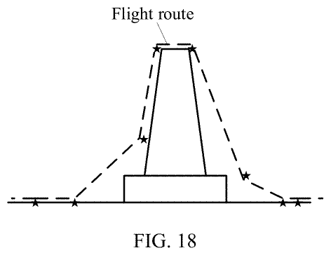

The control device can generate the flight route according to the expansion heights and the coordinate positions of the valid sampling points. With the flight route, number of times of up-down shaking of the unmanned aerial vehicle can be reduced, and further, flight and photographing stabilities of the unmanned aerial vehicle can be increased. For example, as shown in FIG. 18, stars represent the valid sampling points, and the control device can sequentially connect the various valid sampling points after the height expansions to obtain the flight route. As can be seen from comparison between FIG. 14. and FIG. 18, the flight route in FIG. 18 is relatively smoother and more stable.

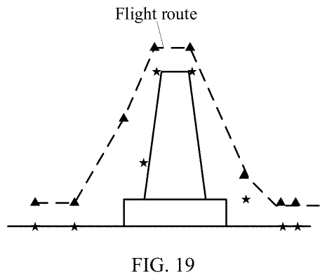

In some embodiments, the control device adds preset heights to the expansion heights of the valid sampling points, and generates the flight route according to the valid sampling points after the preset heights are added and the coordinate positions of the valid sampling points. For example, as shown in FIG. 19, triangles represent the sampling points after the preset heights are added, and the control device can sequentially connect the sampling points after the preset heights are added to obtain the flight route. As can be seen from comparison between FIG. 18 and FIG. 19, the flight route in FIG. 19 is higher than that in FIG. 18, so that the flight safety of the unmanned aerial vehicle during the terrain-following flight can be further ensured.

In the embodiments of the present disclosure, the control device can obtain the buffer area of each sampling point, determine the expansion height of the sampling point according to the heights of the plurality of points in the buffer area, screen all the sampling points to obtain the valid sampling points, and generate the flight route according to the expansion heights of the valid sampling points and the coordinate positions of the valid sampling points, so that the terrain-following flight can be realized, and the problem of collision between the unmanned aerial vehicle and the ground object when there is high object or high terrain between every two adjacent sampling points can be avoided, which improves the flight safety of the unmanned aerial vehicle. In addition, by screening all the sampling points, it can be ensured that the waypoints on the flight route can match the waypoints on the terrain-following flight route, and the power consumption caused by the speed change and altitude adjustment can be reduced. The flight route is generated according to the expansion heights and the coordinate positions of the valid sampling points. With the flight route, the number of times of the up-down shaking of the unmanned aerial vehicle can be reduced, and further, the flight and photographing stabilities of the unmanned aerial vehicle can be increased.

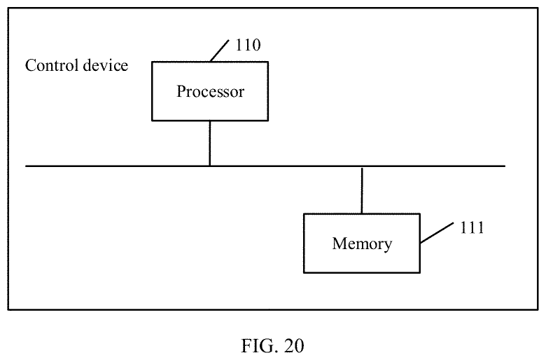

FIG. 20 is a schematic structural diagram of a control device according to an embodiment of the present disclosure. The control device is a control device of an unmanned aerial vehicle, and the control device of the unmanned aerial vehicle is arranged at a vehicle body of the unmanned aerial vehicle, for example, the control device is arranged in a flight controller of the vehicle body of the unmanned aerial vehicle. The control device of the unmanned aerial vehicle can also be arranged in a control terminal configured to control the unmanned aerial vehicle. The control device of the unmanned aerial vehicle includes a memory 111 and a processor 110.

The memory 111 may include a volatile memory, a non-volatile memory, or a combination of memories of different types described above. The processor 110 may be a central processing unit (CPU), and may further include a hardware chip such as an application-specific integrated circuit (ASIC), a programmable logic device (PLD), or a combination thereof. The PLD may be a complex programmable logic device (CPLD), a field-programmable gate array (FPGA), or any combination thereof.

In some embodiments, the memory is configured to store a computer program, and the processor is configured to execute the computer program and, when executing the computer program, perform the following processes: obtaining an initial route; determining a plurality of sampling points from the initial route; determining a buffer area of each sampling point in the plurality of sampling points; determining an expansion height of the sampling point according to heights of a plurality of points in the buffer area of the sampling point; and generating a flight route according to expansion heights and coordinate positions of various sampling points.

For example, the buffer area of the sampling point is an area on the initial route that expands a first preset distance to both sides along the initial route with the sampling point as the center.

For example, the processor is configured to execute the computer program and, when executing the computer program, perform the following processes: adding a preset height to the expansion height of the sampling point; and generating the flight route according to the sampling points after the preset heights are added and the coordinate positions of the sampling points.

For example, the processor is configured to execute the computer program and, when executing the computer program, perform the following process: determining the expansion height of the sampling point according to the heights of all points in the buffer area of the sampling point.

For example, the processor is configured to execute the computer program and, when executing the computer program, perform the following process: determining a maximum height among the heights of all points in the buffer area of the sampling point as the expansion height of the sampling point.

For example, the processor is configured to execute the computer program and, when executing the computer program, perform the following processes: obtaining height of a start feature point and height of an end feature point of the buffer area of the sampling point; obtaining heights of various sampling points in the buffer area of the sampling point; and determining the expansion height of the sampling point according to the height of the start feature point, the height of the end feature point, and the heights of the various sampling points in the buffer area of the sampling point.

For example, the processor is configured to execute the computer program and, when executing the computer program, perform the following process: determining the maximum height among the height of the start feature point, the height of the end feature point, and the heights of the various sampling points in the buffer area of the sampling point as the expansion height of the sampling point.

For example, the processor is configured to execute the computer program and, when executing the computer program, perform the following processes: screening all the sampling points to obtain valid sampling points; and generating the flight route according to expansion heights and coordinate positions of the valid sampling points.

For example, the processor is configured to execute the computer program and, when executing the computer program, perform the following processes: sequentially connecting the sampling points to obtain connection lines of all the sampling points; and screening the sampling points according to characteristic information of the connection lines to obtain the valid sampling points.

For example, the processor is configured to execute the computer program and, when executing the computer program, perform the following process: screening all the sampling points according to a Lamer-Douglas-Puck algorithm to obtain the valid sampling points.

For example, the processor is configured to execute the computer program and, when executing the computer program, perform the following processes: adding preset heights to the expansion heights of the valid sampling points; and generating the flight route according to the valid sampling points after the preset heights are added and the coordinate positions of the valid sampling points.

For example, the initial route is generated through an external instruction.

For example, the initial route is generated through a database.

For example, the database includes at least one of a digital elevation model or a historical flight route.

For example, the processor is configured to execute the computer program and, when executing the computer program, perform the following processes: obtaining a plurality of environmental images photographed by the unmanned aerial vehicle during a level flight to a flight area; and determining the digital elevation model according to the plurality of environmental images, the digital elevation model including coordinate positions and heights of three-dimensional feature points corresponding to various pixel points in the environmental images.

For example, the processor is configured to execute the computer program and, when executing the computer program, perform the following process: using a preset sampling interval to perform sampling processing on the initial route to obtain the plurality of sampling points.

For example, the preset sampling interval is a second preset distance.

For example, when the buffer area of the sampling point is the area on the initial route with the sampling point as the center, radius of the buffer area is greater than or equal to the preset sampling interval.

In the embodiments of the present disclosure, the control device can obtain the buffer area of each sampling point, determine the expansion height of the sampling point according to the heights of the plurality of points in the buffer area, and determine the flight route according to the expansion heights and the coordinate positions of the various sampling points, so that the terrain-following flight can be realized, and the problem of collision between the unmanned aerial vehicle and the ground object when there is high object or high terrain between every two adjacent sampling points can be avoided, which improves the flight safety of the unmanned aerial vehicle.

The embodiments of the present disclosure also provide a control terminal, which is connected with an unmanned aerial vehicle and is configured to control the unmanned aerial vehicle. The control terminal includes a memory and a processor. The memory is configured to store a computer program, and the processor is configured to execute the computer program and, when executing the computer program, implement the flight route generation method described in the embodiments of the present disclosure corresponding to FIGS. 2-15.

The embodiments of the present disclosure also provide an unmanned aerial vehicle, which includes a vehicle body, a propulsion device, and a control device. The control device includes a memory and a processor. The control device and the propulsion device are respectively arranged at the vehicle body of the unmanned aerial vehicle, and the control device is configured to control the propulsion device to drive the unmanned aerial vehicle to move. For example, when the unmanned aerial vehicle is a rotor unmanned aerial vehicle, the propulsion device is a rotor assembly, and the control device can control the rotor assembly to drive the unmanned aerial vehicle to move. Further, the memory of the control device is configured to store a computer program, and the processor of the control device is configured to execute the computer program and, when executing the computer program, implement the flight route generation method described in the embodiments of the present disclosure corresponding to FIGS. 2-15.

The embodiments of the present disclosure also provide an unmanned aerial vehicle system, which includes a control terminal and an unmanned aerial vehicle. The unmanned aerial vehicle system also includes a control device arranged at a body of the control terminal or a vehicle body of the unmanned aerial vehicle. The control device includes a memory and a processor. The memory is configured to store a computer program, and the processor is configured to execute the computer program and, when executing the computer program, implement the flight route generation method described in the embodiments of the present disclosure corresponding to FIGS. 2-15.

The embodiments of the present disclosure also provide a computer readable storage medium which stores a computer program, and the computer program, when executed by a processor, can implement the flight route generation method described in the embodiments of the present disclosure corresponding to FIGS. 2-15, and can also implement the control device described in the embodiments of FIG. 20, which is not repeated herein.

The computer readable storage medium may be an internal storage unit of a test device described in any of the foregoing embodiments, such as a hard disk or a memory of the device. The computer readable storage medium may also be an external storage device of the vehicle control device such as a plug-in hard disk, a smart media card (SMC), a secure digital (SD) card, a flash card, etc. equipped at the device. Further, the computer readable storage medium may also include both the internal storage unit and the external storage device of the device. The computer readable storage medium is configured to store a computer program and other programs and data required by the test device, and can also be configured to temporarily store data that has been output or will be output.

Those of ordinary skill in the art can understand that all or part of the processes in the method of the embodiments described above can be implemented by a program instructing relevant hardware, and the program can be stored in a computer readable storage medium. When the program is executed, one or more of the processes in the method of the embodiments can be performed. The storage medium may be a magnetic disk, an optical disk, a read-only memory (ROM), or a random access memory (RAM), etc. The above are only some embodiments of the present disclosure, which of course are not used to limit the scope of the present disclosure. Therefore, equivalent changes made according to the claims of the present disclosure still fall within the scope of the present disclosure.

What is claimed is:

1. A flight route generation method comprising:
obtaining an initial route;
determining a plurality of sampling points from the initial route;
for each sampling point of the plurality of sampling points:
determining a buffer area of the sampling point; and
determining an expansion height of the sampling point according to heights of a plurality of points in the buffer area of the sampling point; and
generating a flight route according to expansion heights and coordinate positions of the plurality of sampling points.

2. The method of claim 1, wherein the buffer area of the sampling point is an area on the initial route that expands from the sampling point to both sides along the initial route by a preset distance.

3. The method of claim 1, wherein generating the flight route according to the expansion heights and the coordinate positions of the plurality of sampling points includes:
for each sampling point of the plurality of sampling points, adding a preset height to the expansion height of the sampling point to obtain an increased height of the sampling point; and
generating the flight route according to increased heights of the sampling points and the coordinate positions of the sampling points.

4. The method of claim 1, wherein determining the expansion height of the sampling point according to the heights of the plurality of points in the buffer area of the sampling point includes determining the expansion height of the sampling point according to heights of all points in the buffer area of the sampling point.

5. The method of claim 4, wherein determining the expansion height of the sampling point according to the heights of all the points in the buffer area of the sampling point includes determining a maximum height among the heights of all points in the buffer area of the sampling point as the expansion height of the sampling point.

6. The method of claim 1, wherein determining the expansion height of the sampling point according to the heights of the plurality of points in the buffer area of the sampling point includes:
obtaining a height of a start feature point and a height of an end feature point of the buffer area of the sampling point;
obtaining heights of various sampling points in the buffer area of the sampling point; and
determining the expansion height of the sampling point according to the height of the start feature point, the height of the end feature point, and the heights of the various sampling points in the buffer area of the sampling point.

7. The method of claim 6, wherein determining the expansion height of the sampling point according to the height of the start feature point, the height of the end feature point, and the heights of the various sampling points in the buffer area of the sampling point includes determining a maximum height among the height of the start feature point, the height of the end feature point, and the heights of the various sampling points in the buffer area of the sampling point as the expansion height of the sampling point.

8. The method of claim 1, wherein generating the flight route according to the expansion heights and the coordinate positions of the plurality of sampling points includes:
screening the plurality of sampling points to obtain valid sampling points; and
generating the flight route according to expansion heights and coordinate positions of the valid sampling points.

9. The method of claim 8, wherein screening the plurality of sampling points to obtain the valid sampling points includes:
sequentially connecting the sampling points to obtain connection lines; and
screening the plurality of sampling points according to characteristic information of the connection lines to obtain the valid sampling points.

10. The method of claim 8, wherein screening the plurality of sampling points to obtain the valid sampling points includes screening the plurality of sampling points according to a Lamer-Douglas-Puck algorithm to obtain the valid sampling points.

11. The method of claim 8, wherein generating the flight route according to the expansion heights and the coordinate positions of the valid sampling points includes:
for each valid sampling point of the valid sampling points, adding a preset height to the expansion height of the valid sampling point to obtain an increased height of the valid sampling point; and
generating the flight route according to increased heights of the valid sampling points and the coordinate positions of the valid sampling points.

12. The method of claim 1, wherein the initial route is generated according to an external instruction.

13. The method of claim 1, wherein the initial route is generated through a database.

14. The method of claim 13, wherein the database includes at least one of a digital elevation model or a historical flight route.

15. The method of claim 13, further comprising, before obtaining the initial route:
obtaining a plurality of environmental images photographed by an unmanned aerial vehicle during a level flight to a flight area; and
determining a digital elevation model according to the plurality of environmental images, the digital elevation model including coordinate positions and heights of three-dimensional feature points corresponding to various pixel points in the environmental images.

16. The method of claim 1, wherein determining the plurality of sampling points from the initial route includes using a preset sampling interval to perform sampling processing on the initial route to obtain the plurality of sampling points.

17. The method of claim 16, wherein the preset sampling interval is a preset distance.

18. The method of claim 17, wherein:
the buffer area of the sampling point is an area on the initial route with the sampling point as a center; and
a radius of the buffer area is greater than or equal to the preset sampling interval.

19. A control device comprising:
a memory storing a computer program; and
a processor configured to execute the computer program to:
obtain an initial route;
determine a plurality of sampling points from the initial route;
for each sampling point of the plurality of sampling points:
determine a buffer area of the sampling point; and
determine an expansion height of the sampling point according to heights of a plurality of points in the buffer area of the sampling point; and
generating a flight route according to expansion heights and coordinate positions of the plurality of sampling points.

20. An unmanned aerial vehicle comprising:
a vehicle body;
a propulsion device arranged at the vehicle body; and
a control device arranged at the vehicle body and configured to control the propulsion device to drive the unmanned aerial vehicle to move, including:
a memory storing a computer program; and
a processor configured to execute the computer program to:
obtain an initial route;
determine a plurality of sampling points from the initial route;
for each sampling point of the plurality of sampling points:
determine a buffer area of the sampling point; and
determine an expansion height of the sampling point according to heights of a plurality of points in the buffer area of the sampling point; and
generate a flight route according to expansion heights and coordinate positions of the plurality of sampling points.
